(19) United States
(12) Patent Application Publication
(10) Pub. No.: US 2021/0374831 A1
(43) Pub. Date: Dec. 2, 2021

(54) SYSTEM AND METHOD FOR RELATIONSHIP LIFE CYCLE IDENTIFICATION AND RECOMMENDATION IN A SALES ENVIRONMENT

(71) Applicant: Introhive Services Inc., Fredericton (CA)

(72) Inventor: David HUDSON, Fredericton (CA)

(21) Appl. No.: 17/337,380

(22) Filed: Jun. 2, 2021

Related U.S. Application Data
(60) Provisional application No. 63/033,606, filed on Jun. 2, 2020.

(51) Int. Cl. G06Q 30/06; G06N 5/04; G06F 16/28

(52) U.S. Cl. CPC G06Q 30/0631; G06F 16/284; G06N 5/04

(57) ABSTRACT

System and method comprising: collecting, using automated data collection, communication activity data about communication activities between a first entity and a second entity; computing, based on the collected communication activity data, time period based relationship scores corresponding to communications activities between the first entity and the second entity; computing, based on a plurality of the relationship scores corresponding to different time periods, a relationship trend score representing a trend in a relationship lifecycle between the first entity and the second entity; and outputting the relationship trend score.

### RELATED APPLICATIONS

This application claims the benefit of and priority to U.S. Provisional Patent Application No. 63/033,606, filed Jun. 2, 2020, “SYSTEM AND METHOD FOR RELATIONSHIP LIFE CYCLE IDENTIFICATION AND RECOMMENDATION IN A SALES ENVIRONMENT”, the content of which is incorporated herein by reference.

### FIELD

The present disclosure relates to automated methods and systems for efficiently processing digital information about ongoing sales opportunities.

### BACKGROUND

Enterprises such as companies, accounting firms, law firms, universities, partnerships, agencies and governments commonly use customer relationship management (CRM) systems and related technology to manage relationships and interactions with other parties such as customers and potential customers. In particular, CRM systems typically employ electronic computing and communications devices that enable one or more of contact management, sales management and calendar management with the objective of enhancing productivity. An important function provided by CRM systems is digital tracking and storage of data about third parties such as customers and potential customers.

The relationship between a selling enterprise and a customer will typically pass through various phases from the time that relationship begins. These phases make up a Relationship Life Cycle. There are known methods and systems for identifying and defining the Relationship Life Cycle. One of the problems with the existing approaches is the reliance on Questionnaires, Interviews and Surveys to collect the information. These approaches have low (and not pre-determinable) response rates which require a large base sample size to obtain sufficient data to make a determination. The methods of data gathering themselves are subjective and require a significant effort (and duration) to obtain data which ultimately represents a single point in time. In order to plot a relationship trend over time, these survey/interviews have to be conducted continuously.

One of the accepted approaches for determining relationship life cycle uses customer satisfaction (as measured by survey/interview) and customer importance (as gathered using an internal survey). Both of these measures are subjective, as a different response may be obtained from the same customer one day to the next.

Accordingly, there is a need for method and systems to objectively and unobtrusively gather and analyze data about ongoing relationships.

### SUMMARY

According to a first example aspect, is a computer implemented method, comprising: collecting, using automated data collection, communication activity data about communication activities between a first entity and a second entity; computing, based on the collected communication activity data, time period based relationship scores corresponding to communications activities between the first entity and the second entity; computing, based on a plurality of the relationship scores corresponding to different time periods, a relationship trend score representing a trend in a relationship lifecycle between the first entity and the second entity; and outputting the relationship trend score.

According to a second example aspect, a system that includes one or more processors and one or more non-volatile storages coupled to the one or more processers and including software instructions that when executed by the processor configure the system to perform the above method.

### BRIEF DESCRIPTION OF THE DRAWINGS

Reference will now be made, by way of example, to the accompanying drawings which show example embodiments of the present application, and in which:

FIG. 1 is a block diagram illustrating an environment that includes an enterprise network, CRM support system and CRM system in accordance with an example embodiment of the present disclosure.

FIG. 2 is a block diagram of a data compilation module that can be included in the environment of FIG. 1

FIG. 3 is a block diagram illustrating an example of a timeline for an opportunity that can be tracked by one or more of the systems of FIG. 1, according to an example embodiment.

FIG. 4 is a block diagram of a Relationship Lifecycle module that can be included in the environment of FIG. 1.

FIG. 5 is a block diagram illustrating an example computer system for implementing one or more of the systems, modules and components shown in the environment of FIG. 1.

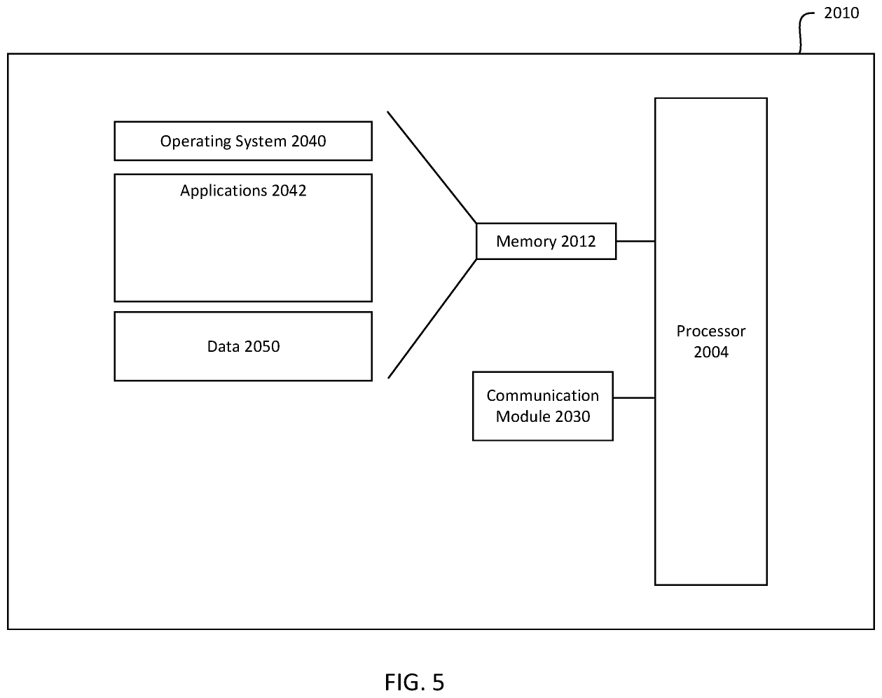

FIG. 6 is a flow diagram of a further method for determining relationship lifecycle data.

Similar reference numerals may have been used in different figures to denote similar components.

### DESCRIPTION OF EXAMPLE EMBODIMENTS

The following embodiments and aspects thereof are described and illustrated in conjunction with systems, tools and methods which are meant to be exemplary and illustrative, not limiting in scope.

Embodiments will now be described more fully hereinafter with reference to the accompanying drawings, in which some, but not all, embodiments of the invention are shown. The features and aspects presented in this disclosure may be embodied in many different forms and should not be construed as limited to the embodiments set forth herein. Where possible, any terms expressed in the singular form herein are meant to also include the plural form and vice versa, unless explicitly stated otherwise. In the present disclosure, use of the term “a”, “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

System Overview

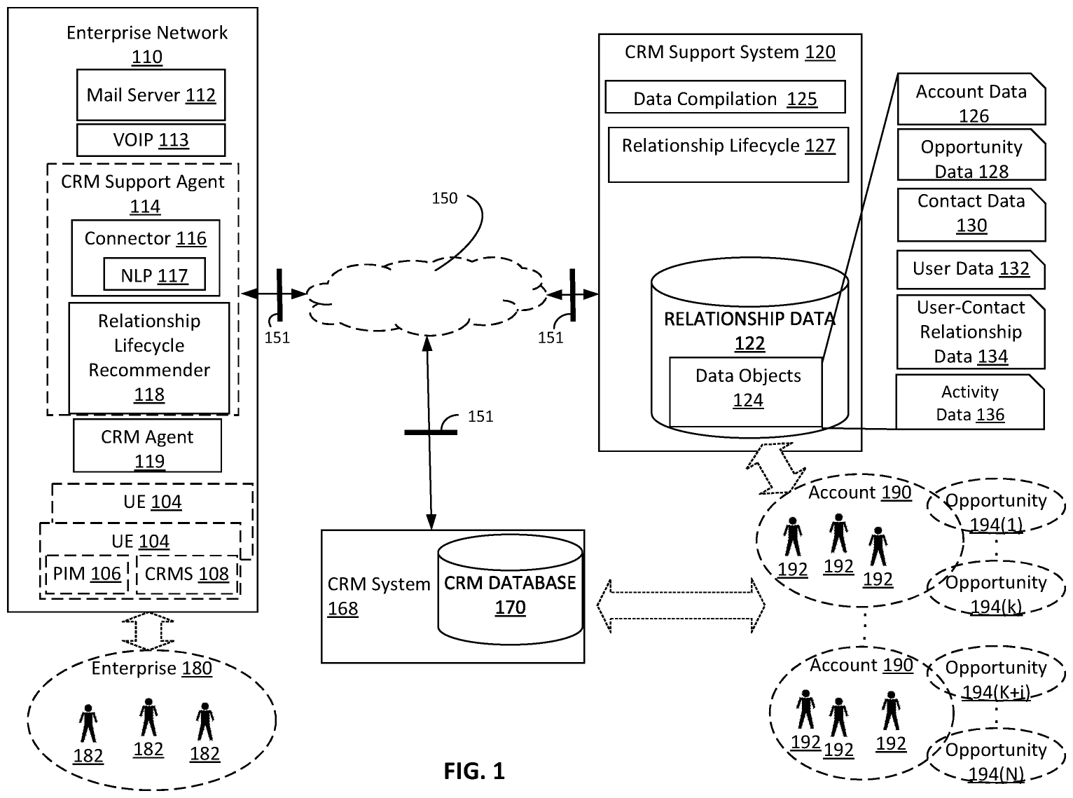

FIG. 1 illustrates an example environment in which the methods and systems described in this disclosure may be implemented. In the example of FIG. 1, the environment includes an enterprise network 110 that supports an enterprise such as a company, firm or other type of organization (referred to in this disclosure as “enterprise 180”) that is selling or otherwise providing a product or service. Accordingly, as used here, “enterprise” can refer to the selling entity in an opportunity, which may for example be a commercial transaction or deal. In example embodiments, a plurality of individuals are registered or otherwise associated with the enterprise network 110 as individual users 182 that are supported by the enterprise network 180. These individual users 182 may for example include employees, owners, partners, consultants, volunteers, and interns of the enterprise 180. In some examples, enterprise 180 could have as few as one individual user 182, and in some examples, enterprise 180 may have thousands or more individual users 182.

At any given time the enterprise 180 has, or is, pursuing commercial relationships with one or more external entities. For example, such external entities could be existing or potential customers, clients or donors or other entities of interest to the enterprise, and may include, among other things, companies, partnerships, universities, firms, government entities, joint venture groups, non-government organizations, charities and other types of groups. As used here, “account” can, for example, refer to the purchasing entity in an opportunity. In example embodiments, external entities that are known to the enterprise 180 are registered in one or more databases of the enterprise as a respective customer or “account” 190. Typically, each account 190 will have an associated set of individual contacts, referred to in this disclosure as “contacts” 192. For example, the individual contacts 192 associated with an account 190 may be employees, owners, partners, consultants, volunteers, and interns of the account 190. Furthermore, at any given time the enterprise 180 will typically have completed or will be pursuing multiple opportunities 194(1) to 194(N) across multiple different accounts 190. In this disclosure, the reference “opportunity 194” will be used to refer an illustrative individual opportunity, and “opportunities 194” used to refer one or more opportunities in the group of opportunities 194(1) to 194(N). Opportunities 194(1) to 194(N) can include open and closed opportunities. An open opportunity can, for example, refer to a commercial deal that the enterprise 180 “seller” is currently pursuing with respect to an account 190 “customer”. A closed opportunity can, for example, refer to a commercial deal that the enterprise 180 “seller” is no longer actively pursuing with respect to an account 190 “customer”, either because the deal has moved into a post sales stage through a successful closing or because a decision has been made that the deal cannot be successfully completed. Thus, an opportunity 194 may for example be a sales opportunity to sell a product or service, and has an opportunity lifetime that can be represented as an opportunity timeline (e.g., duration of time from recognition of existence of the opportunity to closing of the opportunity). The opportunity timeline can typically be divided into a set of successive stages or phases such as the basic stages of a sales cycle (e.g., (i) find leads (prospecting), (ii) connect, (iii) qualify lead, (iv) present, (v) overcome objections and (vi) close). In some examples, a specific opportunity may not be tracked as a discrete opportunity until it has reached a defined stage, for example a “qualified lead” stage.

Enterprise network 110 may, for example, include a plurality of computer devices, servers and systems that are associated with the enterprise 180 and are linked to each other through one or more internal or external communication networks, at least some of which may implement one or more virtual private networks (VPN).

In example embodiments, the environment of FIG. 1 also includes a CRM support system 120 and a CRM system 168, each of which may also include one or more computer devices, servers and systems. One or both of CRM support system 120 and CRM system 168 may, in some examples, be operated by third party organizations that are service providers to the enterprise 180 associated with enterprise network 110. CRM support system 120 and a CRM system 168 are configured to track customer data and other information on behalf of enterprise 180.

In the illustrated example, enterprise network 110, CRM support system 120, and CRM system 168 are each connected to a common communication network 150. Communication network 150 may for example include the Internet, one or more enterprise intranets, wireless wide area networks, wireless local area networks, wired networks and/or other digital data exchange networks. Respective firewalls 151 may be located between the communication network 150 and each of the enterprise network 110, CRM support system 120, and CRM system 168. In different example embodiments, one or more of the features, modules or functions of enterprise network 110, CRM support system 120, and CRM system 168 that are described herein could alternatively be implemented in common systems or systems within a common network. For example, some or all of the features or modules of one or both of CRM support system 120 and CRM system 168 could alternatively be hosted on one or more computer systems located within the enterprise network 110. Alternatively, in some examples, some or all or the agents, modules or systems included in FIG. 1 as part of enterprise network 110 could be remotely hosted (for example at CRM support system 120 or CRM system 168) and accessed by users 182 of the enterprise network 110 through network 150. The locations of various modules, engines, systems and databases as shown in FIG. 1 is illustrative of only one of many possible architecture configurations.

As used here, a “module” or “engine” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit. For example, a hardware processing circuit can include components of a computer system 2010 as described below in respect of FIG. 15. A database or data storage can refer to a collection of information that is stored in an electronically accessible format using a non-transitory storage medium.

Enterprise Network 110

Enterprise network 110 includes at least one mail server 112 for handling and delivering external email that enterprise network 110 exchanges with remote mail servers through communication network 150. Thus, mail server 112 handles external emails that are sent and received by the individual users 182 associated with enterprise network 110. In some examples, mail server 112 may also handle internal emails that are internal within the enterprise network 110.

In some examples, enterprise network 110 includes at least one voice over internet protocol (VOIP) system 113 handling internal and external telephone communications. VOIP system 113 may be configured to log information about incoming and outgoing calls, including phone numbers and associated participant identifying data, timestamp information regarding start and stop times. In some example's VOIP system 113 supports voice messaging that enables incoming messages to be recorded. In some examples, VOIP system 113 may enable incoming and outgoing calls to be recorded.

In example embodiments, enterprise network 110 includes a CRM agent 119 that provides the enterprise network 110 with an interface to CRM system 168.

In example embodiments, enterprise network 110 also includes a CRM support agent 114 that provides the enterprise network 110 with an interface to CRM support system 120. In example embodiments, CRM support agent 114 includes a connector 116 that functions as an interface module between components of the enterprise network 110 and the CRM support system 120. For example, connector 116 is configured to interact with systems within the enterprise network 110 (such as mail server 112, VOIP system 113 and user equipment (UE) devices 104) to extract information about events (such as communication events and other enterprise-account interaction events) and provide that information to CRM support system 120.

As will be described in greater detail below, in example embodiments, the CRM support agent 114 has access to (or includes selected functionality of) a Relationship Lifecycle recommender module 118 that is configured to interact with a user 182 to provide, among other things, intelligent information about the state of relationships and recommended actions.

In example embodiments, enterprise network 110 supports a plurality of UE devices 104. Each enterprise user 182 is associated with one or more respective UE devices 104. In example embodiments, a UE device 104 may be a smartphone, computer tablet, laptop computer, desktop personal computer, wearable electronic device or other communication enabled computer device. In example embodiments, UE devices 104 are configured with a personal information manager (PIM) module 106. Among other things, the PIM module 106 includes an email client, as well as one or more other functions such as calendaring, task managing, contact managing, note-taking, journal logging, and web browsing functions. The PIM module 106 will typically store associated PIM data that includes, among other things, user calendar data, user address book data, user email data and user messaging data. Examples of PIM modules 106 include modules that support basic communications and scheduling services that the user of a UE device 104 is registered with, such as Google Gmail™, Microsoft Outlook Exchange Web Service, and/or Lotus Domino. In example embodiments, some or all of the PIM data associated with a user 182 may be stored locally on the UE device 104 associated with the user, and in some examples, all or parts of the PIM data may be stored at a remote server hosted by or for enterprise network 110 that is accessible through a communication network to the UE device 104. In various embodiments, some or all of the PIM data for users 182 that is stored at UE devices 104 or other remote server is accessible to CRM support agent 114. In some examples, one or more connectors 116 are associated with CRM support agent 114 to enable the CRM support agent 114 to periodically retrieve the PIM data of registered users 182.

In example embodiments, UE devices 104 each include a CRM support client 108 that is configured to interface with the connector 116 of CRM support agent 114 to support the systems and methods described herein, including the exchange of PIM data described above. In example embodiments, a user 182 may have multiple associated UE devices 104 across which PIM data is synchronized. In some examples, a UE device 104 associated with a user could be a virtual device (e.g., a user virtual desktop) that is hosted by a server within enterprise network 110 and accessed by a remote access device (e.g., a thin client device).

CRM System 168

In example embodiments, CRM system 168 may be implemented using a known CRM solution such as, but not limited to, Salesforce.com™, Microsoft Dynamics™, InterAction™ or Maximizer™, and includes a CRM database 170 that includes customer data (e.g., CRM data) for accounts 190 that are tracked by enterprise 180. The CRM data that is stored in a CRM database 170 for an account 190 may for example include: (I) general account data, (II) opportunity data about specific opportunities that the enterprise has undertaken in the past, is currently undertaking, or is proposing to undertake in the future with accounts 190, and (III) individual contact data that includes contact information for individual contacts who are members of the accounts 190.

CRM Support System 120

In example embodiments, CRM support system 120 is configured to provide enhanced CRM information and functionality that supplements CRM System 168, although in some examples the functionality of CRM support system 120 and CRM system 168 may be merged into a single system. CRM support system 120 includes a relationship database 122 for digital electronic storage of relationship data generated in respect of the accounts 190 of interest to enterprise 180. In example embodiments, relationship database 122 may store, in respect of each account 190 (e.g., each customer or client of enterprise 180), relationship data objects 124 that include: (I) account data 126 that provide general information about the account 190, (II) opportunity data 128 about specific opportunities that the enterprise has undertaken in the past, is currently undertaking, or is proposing to undertake in the future with the account 190, (III) individual contact data 130 that includes contact information for individual contacts 192 (e.g., employees) who are associated with the account 190, (IV) user data 132, that includes information about enterprise users 182 who are involved in the relationship with an account 190, (V) user-contact relationship strength data 134, (VI) activity data 136 that includes information about activity events that occur during the timeline of an opportunity that enterprise 180 is pursuing with account 190. The data in relationship database 122 may include some or all of the information stored at CRM database 170, as well as supplemental information.

Data Compilation Module 125

In example embodiments, the CRM Support System 120 includes a data compilation module 125 that interfaces with connector 116 of CRM support agent 114 and other possible data sources to collect, update and process data objects 124 stored in relationship database 122. In some examples, the data compilation module 125 is configured to automatically periodically refresh (e.g., for example on a timed cycle such as once every 24 hours) the content of data objects 124 such that the data maintained in relationship database 122 includes current or near-current information. The data compilation module 125 may periodically refresh the information stored in relationship database 122 based on information from a plurality of sources. For example, data compilation module 125 may obtain data from CRM support agent 114 of enterprise network 110, the CRM database 170 of CRM system 168, from sources within enterprise network 110, and from other data sources that are available through communication network 150. In some examples, one or more of the operations of data compilation module 125 may be manually triggered by a system administrator or user. In some examples, data compilation module 125 may process historic data as part of an onboarding process.

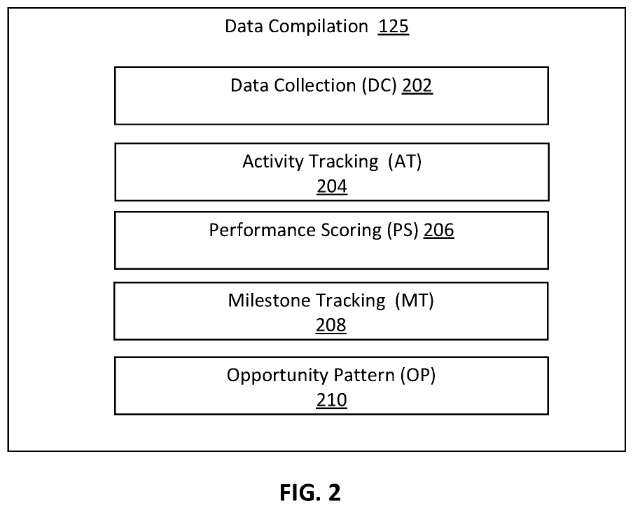

A non-exhaustive set of operations 202, 204, 206, 208, and 210 that may be performed on a scheduled or on-demand basis by the data compilation module 125 are illustrated in FIG. 2. These operations include a data collection operation (DC) 202, an activity tracking (AT) operation 204, a performance scoring (PS) operation 206, a milestone tracking (MT) operation 208, and an opportunity pattern generation (OP) operation 210.

In example embodiments, the CRM support system 120 includes both current and historic records in data objects 124, enabling changes in data, including data of the type included in the Tables 1 to 6 described below, to be tracked over time. For example, both current and historical time-stamped versions of records that include the data fields listed in Tables 1 to 6 may be stored as data objects 124 at relationship database 122.

The data included in data objects 124 in relationship database 122 may be obtained by the data compilation module 125 of CRM support system 120 from different sources using different methods. In an example embodiment, data compilation module 125 includes a data collection operation 202 for collecting information from CRM support agent 114, CRM system 168, and possibly other external sources on a scheduled or on-demand basis. For example, some information may be collected by data collection operation 202 from enterprise users 182 based on data entry provided through user interfaces supported by UEs 104 and/or CRM support agent 114. Some information may be gathered from third party data providers (e.g., contact information and account information pertaining to inactive prospective accounts and contacts, and supplementary information regarding contacts 192 and accounts 190). Some information may be gathered directly or indirectly (for example via CRM agent 119) from CRM system 168. Some information may be gathered through automated monitoring of enterprise network 110 events, including events at mail server 112 and UE device PIM 106 events such as email events, calendar events and contact management events. Data collection operation 302 may configure CRM support system 120 to perform scheduled periodic email, calendar and contact synchs with CRM support agent 114 for updates.

Operations 204 to 210 each process data that is collected by data collection (DC) operation 202 to generate additional data that can be included in data objects 124. Operations 204 to 210 will each be described in greater detail below.

The following Tables 1 to 6 provide examples of variable data fields that may be included in data records that are maintained as data objects 124 in relationship database 124. At least some of the data stored as data objects 124 can be generally be categorized as static (“S=static”) or dynamic (“D=dynamic”) variables. Static variables denote information that is expected to stay reasonably constant and not be largely impacted by events that occur over the duration of an opportunity. Static variables are typically categorical variables. Dynamic variables are expected to change over the course of an opportunity and are impacted by events (for example, events that are tracked as activity data 136) that occur over the duration of an opportunity. Dynamic variables are typically continuous variables. Even though consistency is generally expected in static variables, in at least some examples, static variables may change over time in respect of ongoing opportunities and will be updated accordingly.

Variables are identified as Static and Dynamic in the following Tables 1-6, and a column “Source Operation” is included to indicate the source of the data, e.g., which of the data compilation operations (e.g., raw data collection operation (DC) 202, activity tracking operation (AT) 204, performance scoring (PS) operation 206, milestone tracking (MT) operation 208, and opportunity pattern (OP) operation 210) may, in some examples, perform the collection or computation of the subject variable. In some examples, data included in data objects 124 may be provided by modules that operate in conjunction with data compilation module 125, for example a relationship lifecycle (RLC) module 127, as described in greater detail below.

Account data 126: In example embodiments, the basic data included in account data 126 stored at relationship database 122 may include, for each account 190, data corresponding to some or all of the fields listed in the following Table 1, among other things:

TABLE 1
Account Data Fields:

| Field (S = Static, | | Source |
|---|---|---|
| D = Dynamic) | Field Description | Operation |
| Enterprise ID (S) | Unique identifier assigned to Enterprise | DC 202 |
| | 180 | |
| Account ID (S) | Unique identifier assigned to Account | DC 202 |
| | 190 | |
| Account Industry | Code that identifies primary industry | DC 202 |
| Code (S) | type of customer organization (e.g., | |
| | Standard Industrial Classification (SIC) | |
| | Code and/or North American Industry | |
| | Classification System (NAICS) Codes) | |
| Number of | Number of Employees of Account | DC 202 |
| Employees (S) | Organization | |
| Account Size | Score or category bucket assigned | DC 202 |
| Score (S) | based on size of account organization | |
| | (e.g., organization size of 1500+ | |
| | employees = 10 points; 1000 to 1500 = | |
| | 9 points; 750-1000 = 8 points, etc.; or | |
| | 1-100 employees = Micro entity; 101- | |
| | 500 Small/Medium Enterprise (SME) | |
| | entity; 501+ = Large entity) | |
| Account Annual | Annual Revenue of account | DC 202 |
| Revenue (S) | organization for one or more previous | |
| | years | |
| Owner User ID (S) | User ID of enterprise user 182 who | DC 202 |
| | owns the account (e.g., user 182 who | |
| | has primary responsibility for | |
| | enterprise-account relationship) | |
| Account Name (S) | Name of Account (e.g., company or | DC 202 |
| | organization name) | |
| Account Source (S) | Type of event that generated the | DC 202 |
| | Account (e.g., investor referral, partner | |
| | referral, cross-sell, website request, C- | |
| | level connection, cold call) | |
| Region (S) | Geographic location(s) of the Account | DC 202 |
| | (e.g., buckets such as: North America | |
| | (NA); Europe, Middle East and Africa | |
| | (EMEA)′ Asia Pacific (APAC); Latin | |
| | America (LATAM); South America (SA)) | |
| Top User-Account | The enterprise user 182 that has the | PS 206 |
| Relationship (D) | strongest relationship with the account | |
| | 190 | |
| Enterprise-Account | One or more scores that are indicative | PS 206 |
| Relationship | of a perceived strength of current | |
| Score(s) | relationship between the Enterprise | |
| | and the Account | |
| Enterprise-Account | Indicator of current location in | RLC 127 |
| Relationship | Relationship Lifecycle of Enterprise- | |
| Lifecycle Indicator | Account (e.g., Trend Score and/or | |
| | Categorical Label: Developing; Stable; | |
| | Declining) | |
| Account Status | Indicates Current Status of Accounts | DC 202 |
| Indicator (D) | being targeted (e.g., Current Active | |
| | Account with Open Opportunity; | |
| | Current Active Account with no Open | |
| | Opportunity; Active account, | |
| | Exploratory Relationship; Inactive | |
| | Account; Inactive Account, | |
| | prospecting) | |

Opportunity data 128: In example embodiments, the basic data included in opportunity data 128 stored at relationship data storage 122 may include, for each opportunity with account 190, opportunity records that include data that corresponds to some or all of the fields listed in the following Table 2:

TABLE 2
Opportunity Data Fields:

| Field (S = Static, D = | | Source |
|---|---|---|
| Dynamic) | Field Description | Operation |
| Opportunity ID (S) | Unique identifier assigned to | DC 202 |
| | Opportunity (may be same as Account | |
| | ID in some examples) | |
| Account ID (S) | Account ID of the account that is the | DC 202 |
| | target of the opportunity | |
| Created Date (S) | Date opportunity registered with CRM | DC 202 |
| | support system | |
| Start Date (S) | Date opportunity deemed to be an | DC 202 |
| | “open” opportunity (may be same as or | |
| | different than created date) | |
| Closed Indicator (S) | Indicates if opportunity is closed | DC 202 |
| Closed Date (S) | Date Opportunity was closed | DC 202 |
| Stage Data (D) | Indicates current stage of open | MT 208 |
| | opportunity, and when prior stages | |
| | were completed (e.g., (i) find leads | |
| | (prospecting), (ii) connect, (iii) qualify | |
| | leads, (iv) present, (v) overcome | |
| | objections and (vi) close.) (May be | |
| | updated by an enterprise user and/or | |
| | automatically detected) | |
| Milestone data (D) | Indicates milestone events that have | MT 208 |
| | occurred during the opportunity and | |
| | when they occurred (e.g.: Milestone | |
| | events such as: (1) Detailed Demo; (2) | |
| | Buy-in from Lead Contact; (3) Timeline | |
| | Confirmed) (May be updated by an | |
| | enterprise user and/or automatically | |
| | detected) | |
| Won Indicator (S) | Indicates opportunity closed | MT 208 |
| | successfully or not (e.g., with a sale) | |
| Opportunity Size | Score that represents a size or dollar | DC 202 |
| Score (S) | value of the opportunity (e.g., could be | |
| | based on one or more of monthly | |
| | recurring revenue (MRR), annual | |
| | contract value (ACV) or total contract | |
| | value (TCV) | |
| Projected Budget (S) | Indicates projected budget of Account | DC 202 |
| | for opportunity | |
| Product/Service | ID(s) of products or services that | DC 202 |
| ID (S) | opportunity relates to | |
| Product/Service | Projected number of units of product or | DC 202 |
| Units (S) | service that opportunity will require | |
| Main Contact ID (S) | Contact ID of lead contact for | DC 202 |
| | opportunity with the account | |
| Decision Maker | Contact ID of perceived decision maker | DC 202 |
| ID (S) | at account (May be same as or different | |
| | than Main Contact ID) | |
| Main User ID (S) | User ID of lead user for opportunity | DC 202 |
| Account Team | Contact IDs of all contacts participating | DC 202/ |
| (Purchasing Team) | in the opportunity. (can include | AT 204 |
| (D) | timestamp information indicating team | |
| | entry/exit) | |
| Enterprise Team | User IDs of all enterprise users | DC 202/ |
| (Selling Team) (D) | participating in the opportunity. (can | AT 204 |
| | include timestamp information | |
| | indicating team entry/exit) | |
| Opportunity | Value that indicates a momentum of | PS 206 |
| Momentum Score (D) | the opportunity (e.g., based on trends | |
| | in communication and events between | |
| | buying team and selling team) | |
| Multi-thread Score | Indicates current Multi-thread score, | PS 206 |
| Data (D) | and Multi-thread scores at times when | |
| | stages are completed and/or milestone | |
| | events have occurred. Multi-thread | |
| | score is indicative of a perceived | |
| | suitability of combined members of the | |
| | Account Teams and Enterprise Teams | |
| | that are participating in the | |
| | opportunity. | |
| Communication | One or more values that indicate a | PS 206 |
| Quality Score (D) | qualitative value communication events | |
| | that have been occurring between the | |
| | buying and selling teams.(e.g., could | |
| | include a sentiment trend value that | |
| | indicates positive or negative | |
| | sentiments detected in communication | |
| | events between selling team and | |
| | buying team; a product value that | |
| | indicates number of times references to | |
| | products of the enterprise occur in | |
| | communication events between selling | |
| | team and buying team; a competitor | |
| | value that indicates number of times | |
| | references to a competitor, competitor's | |
| | products, and/or competitor product | |
| | features occur in communication events | |
| | between selling team and buying team. | |
| Enterprise Team Score | Value that indicates perceived strength | PS 206 |
| (D) | of the overall composition of the selling | |
| | team for the opportunity | |
| Account Team | Value that indicates strength of the | PS 206 |
| Score (D) | purchasing team | |
| Main User-Account | Score That Indicates Perceived Strength | PS 206 |
| Team Relationship | of main users' relationship with | |
| Score (D) | members of the Account Team | |
| Main User-Decision | Score That Indicates Perceived Strength | PS 206 |
| Maker Relationship | of main users' relationship with decision | |
| Score (D) | maker of the Account Team | |
| Enterprise Team- | Score That Indicates Perceived Strength | PS 206 |
| Account Team | of overall relationship between selling | |
| Relationship Score (D) | and purchasing teams | |
| Opportunity | Indicator of current location in | RLC 127 |
| Relationship Lifecycle | Opportunity Relationship Lifecycle (e.g., | |
| Indicator (D) | Trend Score and/or Categorical Label: | |
| | Developing; Stable; Declining) | |

Opportunity data 128 may be updated over time as the opportunity 194 progresses, with updates being timestamped. Initial information about an opportunity 194 may be initially provided by an authorized user 182 at the time that an opportunity 194 is opened. In some examples, data compilation module 125 may be configured to gather or infer missing data that is not provided by an authorized user 182 or to check or verify data that is entered. In some examples, an opportunity is created (assigned an opportunity ID and tracked in CRM system and/or CRM support system 120 as a discrete opportunity once a lead is qualified in respect of a sales matter. In some examples, the “start date” for an opportunity may be deemed to be earlier than the creation date, for example when a user indicates that the opportunity was first identified. Other examples, the timing for creation and start dates can be based on other predefined criteria.

Contact Data 130 In example embodiments, the basic data included in contact data 130 stored at relationship data storage 122 may include, for each contact 192 at account 190, contact records that include data that corresponds to some or all of the fields listed in the following Table 3, among other things:

TABLE 3
Contact Data Fields:

| Field (S = Static, | | Source |
|---|---|---|
| D = Dynamic) | Field Description | Operation |
| Contact ID (S) | Unique contact identifier | DC 202 |
| Active/Inactive | Indicates if contact is active or inactive | DC 202/ |
| Indicator (S) | | AT 202 |
| Date Created (S) | Date contact added | DC 202 |
| Account ID (S) | Account ID of the account the contact is | DC 202 |
| | associated with (referred to as | |
| | “contact's account”) | |
| Department (S) | Name of contact's department in | DC 202 |
| | contact's account | |
| Department ID (S) | Numerical value that maps to | DC 202 |
| | Department (based on pre-defined | |
| | mapping rules) | |
| Account Industry | Industry Code for contact's account | DC 202 |
| Code (S) | | |
| Position/Title (S) | The position/title of the contact in | DC 202 |
| | contact's organization | |
| Title Score (S) | Hierarchal Score assigned to Contact | DC 202 |
| | based on contact's position at contact's | |
| | organization (e.g., may be defined by a | |
| | look up table that maps position titles | |
| | to scores: president = 20 points, CEO = | |
| | 20 points, VP = 18 points, senior | |
| | manager = 14 points; partner = 16 | |
| | points, etc.) | |
| Contact-Enterprise | Score That Indicates Perceived Strength | PS 206 |
| Relationship Score (D) | of the Relationship with the Contact | |
| Contact-Enterprise | Indicator of current location in Contact- | RLC 127 |
| Relationship Lifecycle | Enterprise Relationship Lifecycle | |
| Indicator (D) | (e.g., Trend Score and/or Categorical | |
| | Label: Developing; Stable; Declining) | |
| First Name (S) | Contact's First Name | DC 202 |
| Last Name (S) | Contact's Last Name | DC 202 |
| Full Name (S) | Contact's Full Name | DC 202 |
| Primary Email (S) | Contact's Primary Email | DC 202 |
| Primary Phone (S) | Contact's Primary Phone | DC 202 |
| Preferred Marketing | Preferred Event Type for Contact (see | DC 202 |
| Event (S) | for example published US patent No. | |
| | US-2021-0089974 (Serial No. | |
| | 17/027,492), incorporated herein by | |
| | reference) | |
| Contact Origination | Type and ID of event or events that | DC 202 |
| Type (S) | caused contact to be added as an | |
| | Active Contact (e.g., email | |
| | communication event, meeting | |
| | communication event, new outlook or | |
| | other personal information | |
| | management system contact addition) | |
| Image (S) | One or more images obtained from on- | DC 202 |
| | line sources (e.g., Linked-In ™ profile | |
| | picture) | |
| Opportunity ID(s) (D) | ID's of opportunities that the contact is | DC 202/ |
| | associated with | AT 204 |

As noted above, contacts can be indicated as active or inactive. In example embodiments, an active contact can be a contact that has been a party to an event (as tracked in activity data 136 below) within a predefined prior time period (e.g., last 18 months) and/or meets other pre-defined criteria including for example criteria as set by privacy and solicitation legislation or regulations. Inactive contacts are contacts that are not currently active and may in some examples be classified in one or more categories such as inactive historic contacts (e.g., contacts that were previously active contacts), and inactive prospective contacts (e.g., contacts working in industries that are of interest to the enterprise or with active accounts, but who are not historic contacts).

User Data 132 In example embodiments, the basic data included in user data 132 stored at relationship data storage 122 may include, for each user 182 that has a relationship with a contact 192 at the account 190, user records that include data that corresponds to some or all of the variable fields listed in the following Table 4, among other things:

TABLE 4
User Data Fields:

| Field (S = Static, D = | | Source |
|---|---|---|
| Dynamic) | Field Description | Operation |
| User ID (S) | Unique user identifier | DC 202 |
| Account ID (S) | Account ID of the subject account | DC 202 |
| Department (S) | Name of user's department in the | DC 202 |
| | enterprise organization | |
| Title (S) | Title/position of user within enterprise | DC 202 |
| | organization | |
| User-Account | Score That Indicates Perceived Strength | PS 206 |
| Relationship Score (D) | of User's Relationship With Account | |
| (*) | | |
| User-Account | Indicator of current location in User- | RLC 127 |
| Relationship Lifecycle | Account Relationship Lifecycle (e.g., | |
| Indicator(D) (*) | Trend Score and/or Categorical Label: | |
| | Developing; Stable; Declining) | |
| Opportunity ID (D) | Opportunity ID for opportunity for | DC 202/ |
| (*) | which user is member of the enterprise | AT 204 |
| | team (e.g., selling team) | |

* indicates fields that can be repeated for multiple accounts/opportunities

User-Contact Relationship Data 134: In example embodiments, the basic data included in user-contact relationship data 134 stored at relationship data storage 122 may include, for each user-contact relationship that exists between a user 182 within enterprise 180 and a contact 192 within the account 190, user-contact relationship records that include data that corresponds to some or all of the variable fields listed in the following Table 5, among other things:

TABLE 5
User-Contact Relationship Data Fields:

| Field (S = Static, D = | | Source |
|---|---|---|
| Dynamic) | Field Description | Operation |
| User ID (S) | Unique user identifier | DC 202 |
| Contact ID (S) | Contact Unique Identifier | DC 202 |
| Account ID (S) | Contact's Account | DC 202 |
| Start Date (S) | Date when relationship between user | DC 202 |
| | and contact started | |
| Relationship Origination | Event ID and/or event ID of the | DC 202 |
| Indicator (S) | event/event that first triggered | |
| | Contact/user relationship | |
| Active Indicator (S) | Indicates if relationship is currently | DC 202 |
| | active | |
| User-Contact | Score that indicates perceived strength | PS 206 |
| Relationship Score (D) | of User-Contact Relationship | |
| User-Contact | Indicator of current location in user- | RLC 127 |
| Relationship Lifecycle | contact Relationship Lifecycle (e.g., | |
| Indicator (D) | Trend Score and/or Categorical Label: | |
| | Developing; Stable; Declining) | |
| Last Event Date (D) | Date of last recorded event including | AT 204 |
| | user and contact | |

Activity Data 136: Activity data is by nature Dynamic as activity events occur over the course of an opportunity. In example embodiments, the activity data 136 stored at relationship data storage 122 may include data for activity events that are related to an entity-account relationship and opportunities related to that relationship. In examples embodiments, activity records are generated by activity tracking (AT) operation 204 based on data that is connected by data collection (DC) operation 202. For example, DC operation 202 may be configured to provide metadata and/or selected content data about communications passing through mail server 112 and/or VOIP 113 to enable activity tracking (AT) operation 204 to automatically identify trackable activity events and generate activity data 136 in respect of such activities. Activity events may for example include events such as communication events, documentation events, presentation events, and marketing events among other things. Activity data 136 may include respective event records for each logged activity.

By way of example, the enterprise network 110 based CRM support agent 114 may be configured to automatically collect information about communication events between users 182 associated with the enterprise 180 and external contacts 192 associated with an account 190. These communication events may for example be electronic communications such as email, meetings that are tracked in calendar systems and/or scheduled through email communications, and telephone calls that occur through a VOIP system that enables call logging. Each of these interactions have associated electronic data that includes a contact identifier (e.g., email address or phone number for contact 192), time stamp information for the interaction, and a user identifier (e.g., data that identifies the user(s) 182 of the enterprise 180 and account contacts 192 that were involved in the communication event).

In example embodiments, CRM support agent 114 is configured to collect the information about communication events by interacting with devices and systems that are integrated with enterprise network 110 and generate reports that are sent to CRM support system 120 automatically on a scheduled basis or when a predetermined threshold is met or a predetermined event occurs. In some examples, CRM support agent 114 may collect information from an enterprise mail server 112 and VOIP system located within enterprise network 110 and/or from PIM modules 106 associated with UE devices 104, via the connector 116.

In some examples, connector 116 may collect information from the mail server 112. For example, in some embodiments connector 116 is configured to intermittently run a batch process to retrieve email messages from the mail server 112 so that communication activity data can be derived from the email messages and provided through communication network 150 to the relationship database 122. In some examples, the connector 116 is configured to extract selected information from email messages as contact interaction data and other metadata. For each email message, the extracted information may for example include any external email address included in the sender, recipient and carbon copy (CC) and blind carbon copy (BCC) recipient email address fields, along with a send or receive timestamp applied to the email message by the mail server 112. In example embodiments, the extracted information can also include information that identifies any enterprise users 182 that are participating in the email as sender or recipient or CC/BCC recipient. In example embodiments, the extracted information can also include information that identifies any account members 192 that are participating in the email as sender or recipient or CC/BCC recipients.

In example embodiments, meeting requests and invites will be included among the email messages that are processed by mail server 112, and connector 116 is configured to include email addresses in the meeting invitee list and organizer fields in the contact interaction data extracted from the emailed meeting invite. In some examples, connector 116 may also be configured to interface with CRM support clients 108 to receive data from the PIM modules 106 of UE devices 104 associated with the enterprise network 110. In some examples where enterprise network 110 supports phone call logging, for example in Voice-Over-Internet-Protocol (VOIP) implementations supported by a VOIP system, connector 116 may be further configured to interact with a VOIP server to collect information such as metadata about external phone numbers used for outgoing and internal calls, and timestamp information, for inclusion in communication activity data.

In at least some examples, in addition to collecting metadata (e.g., information about participants, time stamps, etc.) about communication events, data collection operation 202 of CRM support system 120 may also collect substantive information. In some examples, that information could be the actual text of information that is included in electronic communications such as emails, text messages, calendar invites. In some examples, a speech to text conversion engine may be used to transcribe audio data from communication events such as phone calls, video conferences and voice mail messages that occur through enterprise network 110, and that text could be stored as part of the activity data.

In some examples, text from electronic messages or text obtained from verbal communication transcriptions may be analyzed and abstracted using an natural language processing (NLP) module 117 that has been trained or otherwise configured to generate vector embeddings that indicate content of interest (including for example, embeddings that represent one or more of word level content, phrase level content, word grouping topical content and/or a sentiment). In some examples, for security or other reasons, such NLP embedding may be performed at the enterprise network 110. For example, connector 116 may include an NLP module 117 that is configured to generate embeddings in respect of electronic and audio communications events and provide that information to CRM support system 120. Among other things, NLP module 117 can perform filtering, text classification and sentiment analysis functions that can enable the substantive content of communications events to be represented as numeric tensors that can be processed using automated solutions. In some examples, NLP module 117 may be configured to detect the occurrence of different types of activity events and milestone events based on the content of communications events, and that information can be used by one or more operations of the data compilation module 125 to populate and/or process activity data 136.

Activity data 136 may include time stamped event records that may include, depending on the type of event and availability of information, variables that correspond to the fields listed in the following Table 6, among other things:

TABLE 6
Activity Data Fields (D):

| Field | Field Description |
|---|---|
| Event ID | Unique identifier assigned to event |
| Account ID* | Identity of Account whose contacts |
| | participated in the event |
| Opportunity ID* | Identity of the opportunity(ies) that |
| | event related to (May for example be |
| | same as Account ID, determined based |
| | on external email domain for example, |
| | or could alternatively deduced based on |
| | or more of participant User IDs) |
| Organizer ID | User ID of enterprise user that |
| | organized event (e.g., email sender or |
| | meeting organizer) |
| Event Type Indicator | Value that identifies the type of |
| | enterprise-account interaction event |
| | (e.g., (i) communication event: |
| | incoming email, outgoing email, |
| | incoming meeting request/calendar |
| | invite, outgoing meeting |
| | request/calendar invite, incoming |
| | phone call, received voicemail message, |
| | outgoing phone call, in-person meeting, |
| | outgoing voicemail message, virtual |
| | meeting, combination of in-person and |
| | virtual meeting; (ii) documentation |
| | event: proposal submitted, draft |
| | statement of work (SOW) submitted; |
| | final SOW submitted; contract |
| | submitted for review). |
| Action Event Indicator | Indicator that indicates if activity is an |
| | Action Event (e.g., event corresponds |
| | to an action taken by enterprise |
| | user(s)) |
| Document ID | ID of document template (can be used |
| | to identify content of standard form |
| | email in the form of a communication |
| | action, or to identify document |
| | template in case of documentation |
| | event) |
| Event Time | Date/time stamp for event (e.g., |
| | sending time stamp for outgoing email; |
| | can be start time in the case of an |
| | event that has a duration) |
| Event Duration and/or | Duration of event (e.g., length of |
| End Time (If applicable) | meeting or phone call), or data and |
| | time stamp indicating end of event |
| NLP Embeddings | Embeddings extracted from |
| | communication events |
| Sentiment Indicator | Indicator provided manually or by |
| | natural language processing algorithm |
| | as to sentiment of event (e.g.: negative |
| | to positive sentiment on scale of 1 to 5, |
| | in example embodiments, may be |
| | determined at CRM support agent 114 |
| | and sent by connector 116 to data |
| | compilation module 125) |
| Content Count* | Counts number of occurrences of |
| | predefined words in communication |
| | event (e.g., product name, competitor |
| | product name). (In example |
| | embodiments, may be determined at |
| | CRM support agent 114 and sent by |
| | connector 116 to data compilation |
| | module 125) |
| Participants-Account* | Contact IDs or other available identifier |
| (ID/Title/Department) | and title/department information for all |
| | individuals involved on account side |
| | who were invited |
| Participants-Enterprise* | User IDs or other available identifier |
| (ID/Title/Department) | and title/department information for all |
| | individuals involved on enterprise side |
| | of event |
| Subject | e.g., Information included in email |
| | Subject fields or meeting “Subject” field |
| | by meeting organizer. |
| Location | e.g., Information included in meeting |
| | “Location” field by meeting organizer |
| Additional Information | Additional descriptive information about |
| | event (e.g., information included in the |
| | open format field of a meeting |
| | scheduling form) |
| Average Enterprise- | Average Enterprise-Contact |
| Contact | Relationship Score of Account |
| Relationship Score | participants |
| Average Title Score | Average Title score of Account |
| | participants |
| Top Title Score | Top Title score among Account |
| | participants |

*Indicates fields that will be repeated as required

In some example embodiments, the extracted information could include additional information from the email such as contact information embedded in the email body, and in this regard, a data scrapping function such as that described in U.S. patent application Ser. No. 16/907,998 filed Jun. 22, 2020, entitled “System and Method for Identifying and Retrieving Signature Contact Information from an Email or Email Thread”, incorporated herein by reference, may be applied to retrieve such information. For example, such a system may also extract additional contact information such as name, title, phone number, social media links, and company name from an email message, for inclusion as part of the contact data 130.

Opportunity Timeline (TL)

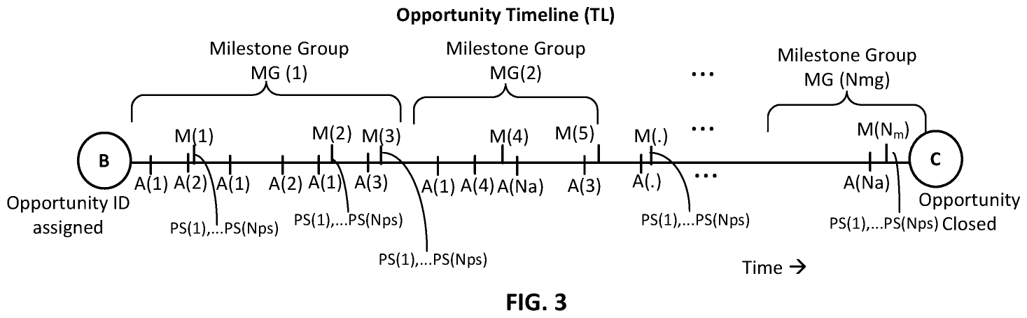

With reference to FIG. 3, CRM support system 120 is configured to process each opportunity 194 as a discrete temporal episode that takes place over a respective opportunity timeline (TL) that has a beginning and an ending. In some examples, the opportunity timeline TL for an opportunity can, for example, begin when the opportunity 194 is allocated a unique opportunity ID in the CRM support system 120 and end when the opportunity is closed, either with a win (e.g., a sale occurs) or a loss (e.g., a decision is made to stop pursuing the opportunity as an open opportunity as no sale is likely to occur).

In example embodiments, the opportunity timeline TL is considered as a set Sm of milestones M(1) to M(Nm) that are either achieved or not achieved during the course of an opportunity 194. In examples, Milestone events M(1) to M(Nn) are predefined events that can indicate that an opportunity is moving towards a successful close and can be influenced by actions of enterprise 180 or actions of an account 190. By way of illustrative examples, defined milestone events may include, among other things: M(1): account user 192 indicates interest; M(2) account user requests pricing information; M(3): first participation of account user 192 with decision making authority; M(i) product demonstration occurs; M(j) account user 192 confirms a purchasing timeline; M(k): draft contract requested; M(l) account legal department becomes involved; M(Nm): Contract executed.

Example embodiments are based on the premise that enterprise 180 and enterprise users 182 can influence the likelihood of milestone events occurring by performing one or more actions that are selected from a defined set Sa of candidate actions A(1) to A(Na). The set Sa of candidate actions A(1), . . . , A(Na) may for example include communications events and other activity events that the enterprise 180 and enterprise users 182 can instigate or participate in. By way of example, actions A(1), . . . A(Na) may include: A(1): outgoing email from enterprise user to one or more account users; A(2): outgoing calendar invite to one or more account users; A(3): videoconference with one or more account users; A(i): in-person meeting with one or more account users; A(Na)): in-person meeting with account users having a title score that exceeds a defined threshold; etc.

As indicated in FIG. 3, one or more of instances of each of the candidate actions can occur in a period leading up to a milestone event M(.). For example, in FIG. 3, instances of actions A(1) and A(2) occur prior to milestone event M(1), and can be perceived as actions that contributed to the occurrence of milestone event M(1); Two instances of action A(1) and one occurrence of action A(2) occur after milestone event M(1) and prior to milestone event M(2), and can be perceived as events that contributed to the occurrence of milestone event M(2).

The timelines TL for different opportunities 194 may vary in that in some successfully closed opportunities some of the milestones included in the set Sm of milestones M(1) to M(Nm) may not be achieved in the same order, or in some cases, not at all. Furthermore, the same milestone in different opportunities may be achieved from different types and quantities of actions, performed in different orders. Thus, at the level of individual actions and milestones, the timelines TL for different opportunities can be relatively stochastic. Typically, however, at a macro-level, opportunities 194 will advance through a generally common set of stages or phases, which are indicated in FIG. 3 as milestone groups MG(1) to MG(Nmg). Although these milestone groups may in some examples correspond to the basic stages of a sales cycle according to known sales cycle models, in at least some examples they are determined independently of the traditional sales cycle stages through analysis based, for example, on historic data collected in relationship database 122. As indicated in FIG. 3, each milestone group MG(1) includes one or more respective milestones. For example, milestone group MG(1) includes milestones M(1) to M(3).

Performance Scoring Operation

At least some of the dynamic variables represented in the above tables are performance scores generated by performance scoring operation 206. As will be explained in greater detail below, at least some of these performance scores are based on the activity data 136 generated by activity tracking operation 204. The performance scores can function as abstracted or coarse indications of the actions that are taken by one or both of the enterprise 180 (and users 182) and the account 190 (and users 192) during the course of an opportunity. In this regard, performance scoring operation 206 may include one or more scoring models for computing a set of performance scores PS(1), . . . , to PS(Nps). Some of the scoring models may be rules based. Some may be machine learning based models that have been trained using supervised learning.

Dynamic performance scores PS(1), . . . , to PS(Nps), computed by performance scoring PS operation 206, may include the following scores identified in Tables 1 to 5 above: Account data 126 (Table 1) includes: a “Top User-Account Relationship” that identifies the enterprise user 182 that has a highest overall relationship score with the subject account 190, and an “Enterprise-Account Relationship Score” that is indicative of the strength of current relationship between the Enterprise and the Account; Contact data 130 (Table 3) includes a “Contact-Enterprise Relationship Score” that that indicates a perceived strength of the relationship of enterprise 180 with the subject contact 192; User data 132 (Table 4) includes a “User-Account Relationship Score” that indicates perceived strength of user's relationship with contact; and User-contact relationship data (Table 5) includes a “User-Contact Relationship Score” that indicates perceived strength of the user-contact relationship. Opportunity data 128 (Table 2) includes: an “Opportunity Momentum Score” that indicates a momentum of the opportunity (e.g., based on trends in communication and events between buying team and selling team); one or more “Multi-thread Score(s)” that indicates if the right depth and breadth of individuals are included in the buying and selling teams and in communication events between such teams, one or more “Communication Quality Score(s)” that indicate a qualitative value of communication events that have been occurring between the buying and selling teams, an account team score, and an enterprise team score; and a number of Relationship Scores.

According to example embodiments, performance scoring PS operation 206 is configured to apply a set of score prediction models for computing a respective set of dynamic score variables when updating the data objects 124. In at least some examples, these dynamic score variables are calculated based on communication events between enterprise users 182 and account contacts 192, such as the communications events that are tracked as part of activity data 136. By way of example, the user-contact relationship score for an enterprise user 182-account contact 192 could be based on a communication score that is based on features such as, among other things: event type (e.g., incoming email, outgoing email, incoming meeting request/calendar invite, outgoing meeting request/calendar invite, incoming phone call, outgoing phone call, in-person meeting, on-line meeting, video conference); frequency (e.g., number of communication events with a defined time period); recentness of communication events; and length of communication event.

By way of illustrative non-limiting example, a contact-user communication score based on frequency of communication, recentness of communication, and type of communication could be determined based on a pre-defined model or algorithm such as follows:

Raw communication score=(total number incoming emails in last week from contact listing user as direct recipient)*(W1)+(total number outgoing emails in last week from user listing contact as direct recipient)*(W2)+(total number incoming emails in last week from contact listing user as CC recipient)*(W3)+(total number outgoing emails in last week from user listing contact as CC recipient)*(W4)+(total number of phone calls, in-person meetings, and virtual meetings involving both user and contact in last week)*(W5)+(total number incoming emails in last month from contact listing user as direct recipient)*(W6)+(total number outgoing emails in last month from user listing contact as direct recipient)*(W7)+(total number incoming emails in last month from contact listing user as CC recipient)*(W8)+(total number outgoing emails in last month from user listing contact as CC recipient)*(W9)+(total number of phone calls, in-person meetings, and virtual meetings involving both user and contact in last month)*(W10)+(total number incoming emails in last 6 months from contact listing user as direct recipient)*(W11)+(total number outgoing emails in last six months from user listing contact as direct recipient)*(W12)+(total number incoming emails in last 6 months from contact listing user as CC recipient)*(W13)+(total number outgoing emails in last six months from user listing contact as CC recipient)*(W14)+(total number of phone calls, in-person meetings, and virtual meetings involving both user and contact in last week)*(W15)+(total number of all communications events involving both user and contact over lifetime of user-contact relationship)*(W16)

Where: W1 to W16 are predetermined weights. (e.g., W1=W2=7; W3=W4=3; W5=8; W6=W7=5; W8=W9=2; W10=6; W11=W12=3; W13=W14=1; W15=4; W16=1).

It will be noted that the above example of the Raw Communication Score enables different types of communication events to be weighted differently, more recent communication events to be rated differently than older communications events, and different types of participation (e.g., sending party, direct “TO” field recipient, or “CC” field recipient in the case of email) to be weighed differently. In some examples, weighting could also be applied based on the number of participants in each communication event. This enables these factors to be given different levels of importance when determining relationship strength.

The particular equation shown above is illustrative and can be varied in different examples. In some applications, some of the communication events noted above may be omitted or combined, among other possibilities.

In some examples, the weights may be manually set, and in some examples, the weights may be learned using a linear regression machine learning based model. In example embodiments, the communication score may be determined using a learned model that has been trained using machine learning techniques based on historic communication and relationship data.

In example embodiments the raw communication score may be normalized to a communication score based on comparison with historical data and/or data for other user-contact relationships or other scaling methodology to a range (for example 0 to 1). In some examples, the normalization may be based on data limited to the enterprise. In some examples, the normalization may be based on data from an industry. In some examples, normalization may be related to a specific account.

In some examples a User-Contact Relationship Score could be a composite of the contacts title score and a communication score based on the above attributes (e.g., contact title score*communication score). In some examples the User-Contact Relationship Score may be decided based only on the communication score. In some example embodiments, User-Contact Relationship Score could be represented as a discrete ranking within a relative scale such as “3=high”, “2=medium”, “1=low”.

In some examples, “Contact-Enterprise Relationship Score” could be based on a combination (e.g., sum or product) of all of the individual User-Contact Relationship Scores that a contact 192 has with users 182 of enterprise 180. In some examples, a “User-Account Relationship Score” could be based on a combination (e.g., sum or product) of all of the individual User-Contact Relationship Scores that a user 182 has with account contacts 192. In some examples, the “Contact-Enterprise Relationship Score” could be based on a combination of all the individual User-Contact Relationship Scores across all user-contact relationships between an enterprise 180 and an account 190. A “Main User—Account Team Relationship Score” could be based on a combination (e.g., sum or product) of all of the individual User-Contact Relationship Scores that a main user 182 (enterprise lead) has with account contacts 192 that make of the Account team) purchasing team) in respect of an opportunity. A “Main User—Decision Maker Relationship Score” could be the individual User-individual Contact Relationship Score between the main user 182 (enterprise lead) and the individual decision maker on the Account side for an opportunity. Enterprise Team-Account Team Relationship Score could be based on a combination (e.g., sum or product) of all of the individual User-Contact Relationship Scores that cover all of the users/contact pairs that make up the Enterprise team and Account team in respect of an opportunity.

In an example embodiment, the Enterprise-Account Relationship Score could be based on a combination (e.g., sum or product) of all of the individual User-Contact Relationship Scores of all of the user 182/contact 192 pairs that are tracked in user-contact relationship data 134 in respect of enterprise 180 and the subject account 190. Note that unlike the Enterprise Team-Account Team Relationship Score described above, the Enterprise-Account Relationship Score is not limited to a particular opportunity or set of opportunities, but covers all known enterprise user-account contact relationships.

In the regard, it will be appreciated from the above description that the in some examples, the various Relationship Scores that are tracked are automatically computed scaler values based on automatically collected data and embeds weighted information about the following aspects of the relationship that is being scored: (1) the number of users and contacts involved; (2) the nature and frequency of communication and other events that have occurred between the users and contacts within defined time periods; and (3) and the title scores of users and contacts. In some examples, user and contact departments and other tracked features can be embedded into the Relationship Scores. In some examples, fewer features can be embedded into the Relationship Scores. In some examples, multiple different types of Relationship Scores may be tracked in respect of each of the different relationship types, based on different combinations of features. For example, the above described Enterprise-Account Relationship Score could be an overall score; a separate “Enterprise-Account Communication Relationship Score” could be based on only the nature and frequency of communication and other events that have occurred between the users and contacts within defined time periods.

In some examples, the “Opportunity Momentum Score” may be based on trends over time in the metrics represented in the raw score calculation noted above, or and/or other communication trends. In this regard, Opportunity Momentum Score can embed communication trends. By way of example, a score model for generating an Opportunity Momentum Score could be configured to generate a score that is between 0(minimum momentum score) and 1(maximum momentum score based on the following input data curated from the data objects 124 in respect of a defined time period: (i) Incoming Emails: Average number of weekly incoming emails relating to Opportunity (e.g., from Account to Enterprise); (ii) Outgoing Emails: Average number of weekly outgoing emails relating to Opportunity (e.g. from Enterprise to Account); (iii) Ratio of Incoming to Outgoing Emails; (iv) Enterprise Email Response Time: Average Time to respond to incoming email from Account; (v) Account Email Response Time: Average Time for Account to respond to email from Enterprise; (vi) Number of Virtual Meetings relating to Opportunity: Average number of weekly meetings with Enterprise by phone or video conference; (vii) Number of In-Person Meetings relating to opportunity: Average number of weekly meetings with Enterprise in-person.

In some examples, various momentum scores can be calculated that reflect trends in each of the relationship scores identified above. For example, the computed Enterprise Team-Account Team Relationship Score can be tracked over the course of an opportunity to identify upward and downward trends, as well as to provide comparison data for other opportunities.

In some examples the “Multi-thread Score” could be computed by a multi-thread model that is configured to calculate multi-thread scores in respect of opportunities 194. In example embodiments, the multi-thread score is numeric value that scores the collective group of account contacts 192 and enterprise users 182 that are associated with an opportunity 194(j) (hereinafter the “opportunity team”). In some examples, the multi-thread score may be based on a combination of at least two of: the number of contacts 192 and users 182 associated with an opportunity; the titles of such contacts 192 and users 182; the departments of such contacts 192 and users 182; and one or more of the relationship scores relating to such contacts 192 and users 182. The model may be configured to give a higher score for title and departmental diversity within the opportunity team.

In a non-limiting example embodiment, multi-thread model 123B may apply a model that includes the following function to calculate a base multi-thread score: BASE MT Score=(SUM of Contact-Enterprise Relationship Scores for all contacts that are members of the Account Team)*(Wt1) PLUS (SUM of Contact-Enterprise Relationship Scores for all contacts that are members of the Enterprise Team)*(Wt2).

In some examples, the BASE MT Score may then be adjusted to account for title and departmental diversity as follows: ADJUSTED MT Score=BASE MT Score*(Wt3)+(number of different account-side departments included in opportunity)*(Wt4)+(number of different title scores included within each account-side department included in opportunity)*(Wt5)+(number of different enterprise-side departments included in opportunity team)*(Wt6)+(number of different title scores included within each enterprise-side department included in opportunity)*(Wt7). Where: Wt1 to Wt7 are predetermined weights that have either been manually set or have been learned using machine learning techniques.

It will be noted that weighting for the type of participation (e.g., sending party, listed in “TO” field, listed in “CC” field in the case of email) of users and contacts is embedded in the Raw Communication Score used as the basis for relationship scoring, and thus is among the factors accounted for in the BASE and ADJUSTED MT Scores. However, in some examples, further factors can be included into the equation for the ADJUSTED MT Scores to allow additional weight based tuning of the scores to account for the different types of participation by Account and Enterprise team members.

In some examples, the BASE MT Score may be calculated based on a sum of all the user-contact relationship scores for user-contact pairs in the opportunity team, rather than or in addition to overall user-account and contact-enterprise relationship scores.

In example embodiments, Multi-thread Score Data for each opportunity can include a set of scores that includes current BASE and ADJUSTED MT Scores, as well as historic BASE and ADJUSTED MT Scores that have been calculated at the completion of stages and milestones of the opportunity.

In some examples, Communication Quality Score(s) for an opportunity 194 may be computed by a Communication Quality Score model that is configured to generate a qualitative value of communication events that have been occurring between the buying and selling teams for a defined duration (e.g., the same duration as the Opportunity momentum score.) The Communication Quality Score may be determined based on information received from NLP module 117, and may for example be based on one or more of: a sentiment trend value that indicates positive or negative sentiments detected in communication events between selling team and buying team; a product value that indicates number of times references to products of the enterprise occur in communication events between selling team and buying team; and a competitor value that indicates number of times references to a competitor, competitor's products, and/or competitor product features occur in communication events.

In some examples, Enterprise Team Score for an opportunity 194 may be computed by a respective model that indicates strength of the selling team. For example, such a score could be similar to the multi-threading score computation noted above, but be performed only from the perspective of the enterprise team. In some examples, the Enterprise Team Score may be based on past successes of one or more selling team members in respect of prior opportunities either with the same account or with past opportunities that have a similar Opportunity Pattern, or both. Similarly, Account Team Score for an opportunity 194 may be computed by a respective model that indicates strength of the selling team, and such a score could be similar to the multi-threading score computation noted above, but be performed only from the perspective of the account team. In some examples, the Account Team Score may be based on the composition of the buying team in respect of prior opportunities with the account that have been closed successfully.

Further examples of relationship scoring techniques that can be applied are described in U.S. Pat. No. 9,633,057, issued Apr. 25, 2017, the content of which is incorporated herein by reference.

In some example embodiments, current and historic values of dynamic performance score variables are included in the data objects. In some examples, historic values of dynamic score variables are included in the data objects. For example, a set of dynamic score variables can be stored as part of (or mapped to) the milestone data for an opportunity defined milestone events are achieved in respect of an opportunity.

Accordingly, referring again to opportunity timeline TL of FIG. 3 each milestone can include a set of respective opportunity performance scores PS(1), . . . PS(Nps) that can be indicative of the activities in a defined period leading up to the achievement of eth milestone.

Milestone Tracking Operation

Referring again to FIG. 2, milestone tracking MT operation 208 is configured to automatically detect and track the occurrence of at least some milestones during the course of an opportunity, and to update the opportunity data 128 accordingly.

In some examples, the NLP module 117 located at CRM agent 114 may be configured to detect content of communications events that indicates the occurrence of milestone events, and provide notification of such to the milestone tracking operation 208. In some examples, milestone tracking operation 208 may employ one or more rules based and/or machine learning based models that processes selected data included in the data objects 124 to detect and track the occurrence of milestones M(1) to M(Nm) in respect of an opportunity 194

In some examples, milestones may be recorded based on manual inputs by enterprise users at UEs 104, received by CRM support system 120 through CRM support agent 114.

Opportunity Pattern Operation

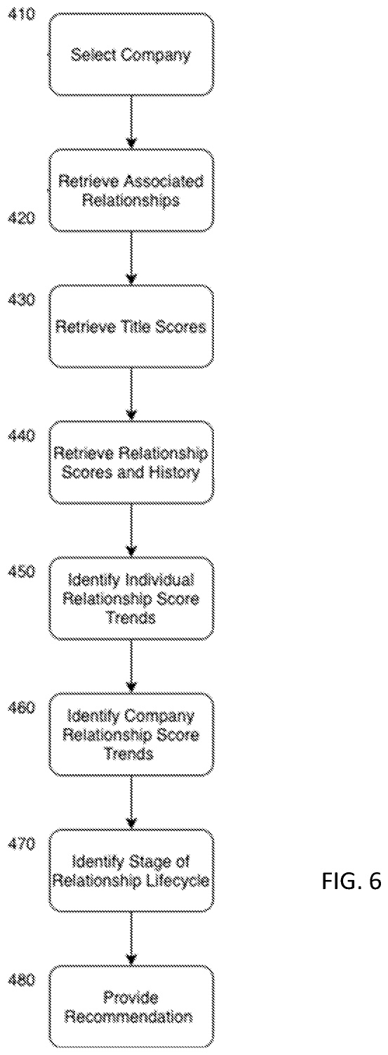

Referring to FIG. 2, in an example embodiment, data compilation module 125 includes an opportunity pattern operation 210 that is configured to generate a respective opportunity pattern for each opportunity 194. The opportunity patterns are intended to allow similar opportunities 194 to be identified based on an ordered set (e.g., a feature vector FV) of the static variables of the opportunities 194 and the accounts 190 that the opportunities are associated with. Examples of static account and opportunity variables are indicated above in Tables 1 and 2, denoted with an “(S)”. As noted above, static variables denote information that is expected to stay reasonably constant and not be significantly impacted by events that occur over the duration of an opportunity. A set of at least some of these static opportunity variables are selected for inclusion as static variables SF(1), . . . , SF(Ns) in a static feature vector FV to represent each opportunity 194. For example, the feature vector FV(1) for opportunity O(1) in the matrix of FIG. 6 will comprise the first row of static variables SF(1), . . . , SF(Ns). As the feature vector FV for each opportunity is based on static variables, it will typically remain the same for an opportunity once calculated and need not be updated unless a change occurs one of the feature variables.

Opportunity variables are typically categorical (either ordinal or nominal) and preprocessing may be applied to collected data to compute appropriate variables; e.g., converting continuous variables to categorical. To ensure that these categorical variables can be consumed by system models, categorical variables can be encoded to numerical values while maintaining either the ordinal or nominal nature of the underlying data. By way of example, in one embodiment, one or more of the following static variables from the above Tables 1 and 2 may be represented using or more respective static variables SF(1), . . . , SF(Ns): Account ID; Account Industry Code; Account Size Score; Account Annual Revenue; Region; Account Source; Opportunity Size Score; Projected Budget; Product/Service ID; Product/Service Units; Main Contact ID; Main User ID. Thus, each static variables SF(1), . . . , SF(Ns), relates to a different feature that numerically represents a unique property or set of properties of the opportunity 194. In example embodiments, the pattern generation module 121 can be preconfigured with respective functions for generating one or more of the respective static variables SF(1), . . . , SF(Ns).

Relationship Lifecycle Module 127

As noted above, the relationships between enterprise 182 and an account 190 can progress through phases. Recognizing which of these lifecycle phases that a relationship is currently in can provide information that can be used to guide actions that are taken by enterprise users 182 with respect to the account 190.

In this regard, CRM support system 120 includes a computer implemented Relationship Lifecycle module 127 that is configured to automatically compute what lifecycle phase different types of relationships are currently in, and generate feedback that can be provided through relationship lifecycle recommender 118 to one or more enterprise users 182. As noted above, in example embodiments, the CRM support agent 114 may include relationship lifecycle recommender 118, which is configured to interact with relationship lifecycle module 127 and the UE 104 associated with a user 182 to provide, among other things, intelligent information about how a relationship is progressing and recommended next best actions.

In example embodiments, Relationship Lifecycle module 127 is configured to compute Relationship Lifecycle Indicators for one or more different types of relationships. Relationship Lifecycle module 127 may be configured to compute Relationship Lifecycle Indicators on a periodic basis or an on-demand basis, or automatically in response to a triggering event. For example, Relationship Lifecycle module 127 may compute Relationship Lifecycle Indicators when every performance scoring operation 206 generates new performance scores.

For example, as noted in the above tables, Relationship Lifecycle Indicators can be computed and tracked for different types of relationships as summarized in the following table 7.

TABLE 7
Relationship Lifecycle Indicators

| Types of | |
|---|---|
| Relationship | |
| Lifestyle | |
| Indicator | Description |
| (1) Enterprise- | Indicator of current location in Relationship Lifecycle |
| Account | of Enterprise-Account; determined based on trends in |
| Relationship | Enterprise-Account Relationship Score(s). |
| Lifecycle | |
| Indicator | |
| (2) Opportunity | Indicator of current location in a specific Opportunity |
| Relationship | Relationship Lifecycle; determined based on trends in |
| Lifecycle | Enterprise Team-Account Team Relationship Score for |
| Indicator | the specific opportunity. (Note may be the same as or |
| | similar to Enterprise-Account Relationship Lifecycle in |
| | some examples, for example where an account is a |
| | single opportunity account) |
| (3) Contact- | Indicator of current location in relationship lifecycle of |
| Enterprise | a specific account Contact with the selling enterprise |
| Relationship | as a whole; determined based on trends in Contact- |
| Lifecycle | Enterprise Relationship Score for the specific contact. |
| Indicator | |
| (4) User-Account | Indicator of current location in relationship lifecycle of |
| Relationship | a specific enterprise user with a specific account; |
| Lifecycle | determined based on trends in User-Account |
| Indicator | Enterprise Relationship Score for the specific contact. |
| (5) User-Contact | Indicator of current location in a specific user-contact |
| Relationship | Relationship Lifecycle; determined based on trends in |
| Lifestyle | specific user-contact Relationship Score. |
| Indicator | |

In the above noted examples, the respective Relationship Lifecycle Indicators are each computed by Relationship Lifecycle module 127 based on trends in corresponding Relationship Scores that are calculated by performance scoring (PS) operation 206.

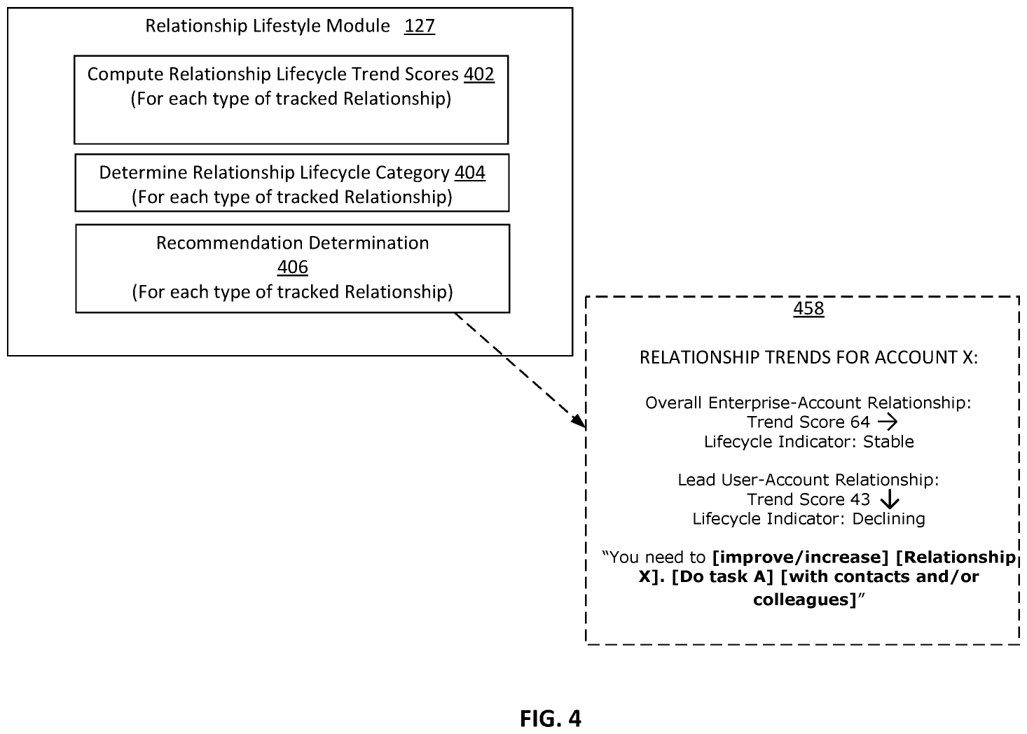

FIG. 4 illustrates a block diagram of operations that can be performed by Relationship Lifecycle module 127. In one example, the relationship lifecycle indicator for a respective relationship can include a numerical Relationship Trend Score that is a weighted average or weighted sum of the corresponding relationship score over a set of predefined periods. In this regard, Relationship Lifecycle module 127 can include an operation 402 for computing a continuous value Relationship Trend Score for each type of tracked relationship score. By way of non-limiting example, a Relationship Trend Score based on a weighted sum could be computed as follows:

Relationship Trend Score=(Current Relationship Score)*(Wt1)PLUS(Relationship Score for previous month, e.g., Relationship Score 30 days ago)*(Wt2)PLUS(Relationship Score for month prior to previous month, e.g., Relationship Score 60 days ago)*(Wt3)

Where: Wt1 to Wt3 are predetermined weights that have either been manually set or have been learned using machine learning techniques. Different sets of weight parameters and different time periods may be used for different types of relationships (e.g., The Relationship Trend Score calculation for a User-Contact Relationship may use different weights, reference time periods and numbers of scores than the Relationship Trend Score calculation for an Enterprise-Account Relationship).

Table 8 below provides an example of a Relationship Trend Score calculation for the example where Wt1=80%, Wt2=65%, and Wt3=40%.

TABLE 8
RELATIONSHIP LIFECYCLE INDICATOR EXAMPLE

| | Relation- | | | Indicator(s) | |
|---|---|---|---|---|---|
| | ship | Relation- | Relation- | Relation- | Relation- |
| | Score | ship | ship | ship | ship |
| | (Current | Score | Score | Trend | Lifecycle |
| Month | Month) | Month-1 | Month-2 | Score | Category |
| 0 | 40 | 30 | 35 | 66 | Stable |
| (Current) | | | | | |
| −1 | 30 | 35 | 35 | 61 | Stable |
| −2 | 35 | 35 | 30 | 65 | Developing |
| −3 | 35 | 30 | 26 | 58 | Developing |
| −4 | 30 | 26 | 24 | 51 | Developing |
| −5 | 26 | 24 | 20 | 46 | Developing |

As shown in the above table, in some examples the Relationship Lifecycle Indicator for a respective relationship can also, or alternatively, include a Relationship Lifecycle Category assignment. In this regard, Relationship Lifecycle module 127 can include an operation 404 for determining a Relationship Lifecycle Category (e.g., Developing; Stable (or Mature); Declining).

In some examples, operation 404 may map a set of relationship trend scores to a category based on predefined thresholds or a predefined lookup tables, which may be specific to the type of relationship. Different mapping parameters may be used for different types of relationships (e.g., The Relationship Lifecycle Category mapping for a User-Contact Relationship may use different thresholds/lookup tables than the Relationship Lifecycle Category mapping for an Enterprise-Account Relationship).

In at least some examples, Relationship Lifestyle Category may be determined based on trends in a set of current and recent Relationship Trend Scores for a defined duration, thereby embedding a longer time duration into a Relationship Lifestyle Category relative to a single Relationship Trend Score. For example, the current Relationship Lifestyle Category may be based variations on the Relationship Trend Scores over the last 3 month period. For example, if the Relationship Trend Scores for the current month is within a defined threshold variation (for example 8%) of the average of the scores for the previous two periods (for example the Relationship Trend Score calculated for −30 days (−1 months) and −60 (−2 months)) then the current Relationship Lifestyle Category is “stable”. A variation of greater than threshold in the positive direction would be classified as “Developing”. A variation of greater than threshold in the negative direction would be classified as “Declining”. Thus the current Relationship Lifestyle Category can be selected using predefined criteria, from a set of possible categories, based on a set of Relationship Trend Scores for different time periods.

It will be noted that based on the types of relationship lifecycle relationships (and corresponding indicators) identified in table 7, from the perspective of enterprise 180, a variety of indicators (that can each include one or both of a relationship trend score and a lifecycle) can be generated in respect of a specific account 190 at any given time, including (1) an overall Enterprise-Account Relationship Lifecycle Indicator; (2) Opportunity Relationship Lifecycle Indicators for each open opportunity with the account 190; (3) Contact-Enterprise Relationship Lifecycle Indicator for one or more of the individual contacts 192 (for example, for a lead contact or a decision maker contact); (4) User-Account Relationship Lifecycle Indicator for one or more of the enterprise's representatives (users 182) with the account overall; and (5) User-Contact Relationship Lifestyle Indicator for one or more individual relationships (for example, for a lead user with an account decision maker).

Although a three monthly relationship scores are mentioned in the above examples, as few as 2 and more than three relationship scores can be used when determining a relationship trend score, and the interval spacing between the relationship scores can be other than 30 days. Each of the relationship scores determined for different dates will correspond to different time periods, however in some cases the time periods embedded in the underlying relationship scores may partially overlap. For example, it will be appreciated from the above communication score equation, each relationship score may embed, with different degrees of weighting, information about communication activities for successive periods going back 6 months. Accordingly, relationship scores calculated at a 30-day interval will cover two time periods that partially overlap, and therefore may embed information (that can be differently weighted) about the same communications activities from the overlapping duration.

Referring again to FIG. 4, Relationship Lifecycle module 127 can include a recommendation determination operation 406 that is configured to map the computed relationship lifecycle indicators to concrete user feedback data 458 that can be provided to individual user UEs 104 (for example through an interface provided by relationship lifecycle recommender module 118). As indicated in FIG. 4, the feedback data 458 can include the Trend Scores and lifecycle categories indicators for different types of relationships. In some examples, the trend scores and lifecycle categories could be presented via an interface provided by CRMS 108 on individual user UEs 104. In some examples, lifecycle categories could be represented with visual icons on UEs 104, such as a right horizontal arrow for stable, and down arrow for declining, and an up arrow for developing.

In examples, the computed relationship trend scores can be used to determine one or more specific action recommendations that would enable the respective performance score to be improved. In this regard, action recommendations in feedback 458 could take a form such as “You need to [improve/increase] [Relationship X]. [Do task A] [with contacts and/or colleagues]”.

For example, as noted above, a component of the relationship scores can be based on the number of outgoing emails within a time duration to a certain title score's contact. Relationship Lifecycle module 127 can be configured to compute the increase in the number of weekly outgoing emails that would be required to reverse a declining relationship score and obtain a resulting relationship trend score that increases by a defined threshold amount. For example, a resulting recommendation to lead user could be “Your relationship lifecycle with Account X is in decline; Your need to have a weekly communication activity with your contacts {list highest title score contacts} to reverse this negative relationship trend”.

In some examples, feedback data 458 may be provided in a periodic digest that the user 182 receives (for example in an email, or through an interface provided by CRMS 108) according to a configurable schedule (e.g. daily, every 3 days or weekly). Similarly, the same content may be available in a panel display in the users' email interface and could, for example, be displayed when viewing related content (e.g. an email to/from a contact from that account, or a meeting invite relating to an account).

In both the above feedback mechanisms, the user 182 can have the option to sync the recommendations to a task list so that the user 182 can access the information later through their local CRM interface or through their CRMS 108 interface (or other productivity tool). In some examples, the action of users 182 on feedback recommendations 458 can be tracked by CRM support agent and communicated to CRM support system 120, providing the additional benefit of providing user-feedback to the system 120 indicating which recommendations were useful. This information can be used to update the model parameters used in the NBA module 127 to drive more useful recommendations in the future.

Information included in feedback data 458 can also or alternatively be displayed in a dashboard format on an interface provided on UE device 104 by CRMS 108 so that the user 182 can easily find recent recommendations for particular opportunities, accounts and contacts.

In at least some examples, the described systems and methods may improve the efficiency and accuracy of performing comparative data analysis to generate action recommendations, thereby enabling one or more of the CRM system computing devices that make up the CRM support system 120, CRM system 168 and enterprise network 110 to expend fewer computing resources, consume less power and/or require fewer data and power consuming human interactions than might otherwise be required to achieve similar results in the absence of the disclosed systems and methods.

Data objects 124 can be electronically stored in various database formats in different embodiments. In some examples, data objects 124 may include records stored as part of relational database. In some examples a record may be a virtual record that identifies or links to other data sources for the actual content of the feature field of that record. In some cases, feature fields of a record may include sub-records comprising multiple fields or links to such sub-records.

Example Computer System

In example embodiments, the components, modules, systems and agents included in enterprise network 110, CRM support system 120 and CRM system 168 can be implemented using one or more computer devices, servers or systems that each include a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a digital signal processor, or another hardware processing circuit.

Referring to FIG. 15, an example embodiment of a computer system 2010 for implementing one or more of the modules, systems and agents included in enterprise network 110, CRM support system 120 and CRM system 168 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 202 executed by the processor 2004 are also stored in the persistent memory. The applications 2042 can include software instructions for implementing the systems, methods, agents and modules described above.

The system 2010 is configured to store data that may include data objects such as data objects 124.

FIG. 6 illustrates an example of a method according to further method. FIG. 6 is a flow chart of actions performed by one or more components in the system of FIG. 1 to identify the current place in the relationship life cycle and any suggestions if actions are required to correct a decline.

Step 410—The identification of a company's (i.e., an account's) relationship life cycle is triggered. This may be, but not limited to, based on a scheduled batch process, or upon demand. The company is selected from the CRM (240)

Step 420—retrieve the contacts associated with the company (account).

Step 430—retrieve the Title Scores of the contacts of Step 420 from the Relationship Database 122.

Step 440—retrieves the current relationship strengths (relationship score) of the contacts from the Relationship Database 122. The historical relationship strengths of the contacts also be retrieved.

Step 450—identify the relationship score trends for each individual contact identified in Step 420.

Step 460—identify an enterprise-account relationship score. This score will be determined by using the individual relationship score trends and factoring in the individuals', for example but not limited to, Title Score or Department. The system will use this combined score over a period of time to identify a relationship life cycle trend score.

Step 470—utilize the trend data realized in Step 460 and determine the current stage of the relationship life cycle. These stages could be, but not limited to, Developing, Mature, or Declining.

Step 480—provide a recommended action if the company relationship score trend is in the Declining stage or appears to be entering the Declining stage. This recommendation would be based on the individual relationship score trends combined with, but not limited to, the title score or department.

In some examples, the performance scoring operation 206 may also include a partner success function to calculate a “partner success score” for an individual enterprise user 182. For example, such a score could be calculated and used as follows: (1) A partner is selected to perform a partner success check on. A partner would be a user 182 in a role such as, but not limited to, a Sales Leader, a Company Partner, or a Director. The role used as ‘Partner’ within this embodiment may be determined based on the title score of the role. (2) The partner success function will retrieve the information on all communications that the partner has made within the enterprise. This communication information is retrieved from the relations database 122. (3) The partner success function analyzes all internal relationships, communications, and events (meetings). A score is generated to represent the partner's communication level with each department, region, office, role, or individual. The score generated for an event is modified by the number of individuals involved. For example, but not limited to, a 1 on 1 meeting (or email) versus a meeting with 12 individuals would be rated higher. An email (or meeting) that also contains a client has a higher rating than one that does not. (4) The partner success function will compare the generated score with previously generated scores to identify any changes over a period of time. The comparisons are generated with each department, region, office, role, or individual. (5) The partner success function generates the comparisons with each department, region, office, role, or individual. (6) partner success function will evaluate the success of the partner based on a criteria such as, but not limited to, success of deal closure, monthly revenue, quarterly revenue, annual revenue, number of key projects, number of key accounts, project types, number of referrals, length of time required to successfully close opportunity, and success of referrals (7) the partner success function will review the success of the partner determined in (6), compare that with previously calculated success scores for the partner's business unit or role, and will recommend an action based on the differences in the scores between the two.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method, comprising:
collecting, using automated data collection, communication activity data about communication activities between a first entity and a second entity;
computing, based on the collected communication activity data, time period based relationship scores corresponding to communications activities between the first entity and the second entity;
computing, based on a plurality of the relationship scores corresponding to different time periods, a relationship trend score representing a trend in a relationship lifecycle between the first entity and the second entity; and
outputting the relationship trend score.

2. The method of claim 1 wherein the different time periods include successive, partially overlapping time periods.

3. The computer implemented method of claim 1 wherein:
the communication activity data comprises data about communication activities, corresponding to the different time periods, between a plurality of individual users associated with the first entity and a plurality of individual contacts associated with the second entity, and
the plurality of relationship scores includes respective user-contact relationship scores, the respective user-contact relationship scores each being computed based on a number of communication activities between a respective individual user from the plurality of individual users, and a respective individual contact from the plurality of individual contacts, during a respective one of the different time periods.

4. The computer implemented method of claim 3 wherein the relationship trend score includes a user-contact relationship trend score for a respective individual user and respective individual contact that is based on a plurality of the user-contact relationship scores computed for the respective individual user and respective individual contact.

5. The computer implemented method of claim 3 wherein:
the plurality of relationship scores includes first entity-second entity relationship scores for the different time periods, each respective first entity-second entity relationship score being based on the respective user-contact relationship scores for a plurality of the individual users and the individual contacts, and the relationship trend score includes a first entity-second entity relationship trend score representing an overall trend in a relationship between the first entity and second entity, the first entity-second entity relationship trend score being determined based on a plurality of the first entity-second entity relationship scores for the different time-periods.

6. The computer implemented method of claim 3 wherein the respective user-contact relationship scores are computed based also on a title score of the respective individual contact, the title score of the respective individual contact being indicative of a position of the respective individual contact within a hierarchy of the second entity.

7. The computer implemented method of claim 1 wherein collecting communication activity data comprises:
storing as part of electronically stored relationship data, user data identifying a plurality of individual users that are associated with a first entity and the individual users' respective user email addresses, and contact data identifying a plurality of individual contacts associated with a second entity and the individual contacts' respective contact email addresses;
monitoring emails exchanged through an enterprise mail server of the first entity and automatically extracting email communication data including email addresses included in one or more of From, To and Carbon copy (Cc) fields of the emails; and
identifying based on comparing the extracted email communication data with the user data and the contact data, emails that are exchanged between one or more of the individual users with one or more of the individual contacts and storing, as part of the electronically stored relationship data, for each identified email, email activity data that includes: (i) time stamp data for the email and; (ii) participant data that identifies the one or more individual users and the one or more individual contacts whose email addresses are included in one or more of the From, To or Cc fields of the identified email;
wherein the communication activity data includes the email activity data.

8. The computer implemented method of claim 1 wherein computing the time period based relationship scores corresponding to communications activities between the first entity and the second entity comprising applying less weight to older communications activities than more recent communications activities.

9. The computer implemented method of claim 1 comprising:
computing a plurality of the relationship trend scores, each corresponding to a different, successive time period;
selecting a relationship lifecycle category from a set of possible categories; and
based on a trend represented in the plurality of the relationship trend scores;
and outputting the selected relationship lifecycle category.

10. The computer implemented method of claim 1 comprising:
selecting, from a set of possible actions, an action that will increase the relationship trend score and outputting data indicating the action for an individual user associated with the first entity.

11. A system comprising:
one or more processors and one or more non-volatile storages coupled to the one or more processers and including software instructions that when executed by the processor configure the one or more processors to:
collect, using automated data collection, communication activity data about communication activities between a first entity and a second entity;
compute, based on the collected communication activity data, time period based relationship scores corresponding to communications activities between the first entity and the second entity;
compute, based on a plurality of the relationship scores corresponding to different time periods, a relationship trend score representing a trend in a relationship lifecycle between the first entity and the second entity; and
output the relationship trend score.

12. The system of claim 11 wherein the different time periods include successive, partially overlapping time periods.

13. The system of claim 11 wherein:
the communication activity data comprises data about communication activities, corresponding to the different time periods, between a plurality of individual users associated with the first entity and a plurality of individual contacts associated with the second entity, and
the plurality of relationship scores includes respective user-contact relationship scores, the respective user-contact relationship scores each being computed based on a number of communication activities between a respective individual user from the plurality of individual users, and a respective individual contact from the plurality of individual contacts, during a respective one of the different time periods.

14. The system of claim 13 wherein the relationship trend score includes a user-contact relationship trend score for a respective individual user and respective individual contact that is based on a plurality of the user-contact relationship scores computed for the respective individual user and respective individual contact.

15. The system of claim 13 wherein:
the plurality of relationship scores includes first entity-second entity relationship scores for the different time periods, each respective first entity-second entity relationship score being based on the respective user-contact relationship scores for a plurality of the individual users and the individual contacts, and the relationship trend score includes a first entity-second entity relationship trend score representing an overall trend in a relationship between the first entity and second entity, the first entity-second entity relationship trend score being determined based on a plurality of the first entity-second entity relationship scores for the different time-periods.

16. The system of claim 13 wherein the respective user-contact relationship scores are computed based also on a title score of the respective individual contact, the title score of the respective individual contact being indicative of a position of the respective individual contact within a hierarchy of the second entity.

17. The system of claim 11 wherein the time period based relationship scores corresponding to communications activities between the first entity and the second entity are computed by applying less weight to older communications activities than more recent communications activities.

18. The system of claim 11, wherein the one or more processors are configured to:
compute a plurality of the relationship trend scores, each corresponding to a different, successive time period;
select a relationship lifecycle category from a set of possible categories; and
based on a trend represented in the plurality of the relationship trend scores;
and output the selected relationship lifecycle category.

19. The system of claim 11, wherein the one or more processors are configured to:
select, from a set of possible actions, an action that will increase the relationship trend score and output data indicating the action for an individual user associated with the first entity.

20. A computer readable medium storing software instructions that, when executed, configure one or more processors to collectively:
collect, using automated data collection, communication activity data about communication activities between a first entity and a second entity;
compute, based on the collected communication activity data, time period based relationship scores corresponding to communications activities between the first entity and the second entity;
compute, based on a plurality of the relationship scores corresponding to different time periods, a relationship trend score representing a trend in a relationship lifecycle between the first entity and the second entity; and
output the relationship trend score.
